(19) United States
(12) Patent Application Publication
(10) Pub. No.: US 2014/0000315 A1
(43) Pub. Date: Jan. 2, 2014

(54) PROCESS FOR OBTAINING A GLASS-CERAMIC MATERIAL THAT IS OPTICALLY TRANSPARENT IN THE INFRARED

(71) Applicants: Laurent Calvez, Thorigne-Fouillard (FR); Xiang Hua Zhang, Cesson Sevigne (FR); Mathieu Hubert, Chasne Sur Illet (FR); Gaëlle Delaizir, Limoges (FR)

(72) Inventors: Laurent Calvez, Thorigne-Fouillard (FR); Xiang Hua Zhang, Cesson Sevigne (FR); Mathieu Hubert, Chasne Sur Illet (FR); Gaëlle Delaizir, Limoges (FR)

(73) Assignees: UNIVERSITE DE RENNES 1, Rennes Cedex (FR); CNRS, Paris 16 (FR)

(21) Appl. No.: 13/992,095

(22) PCT Filed: Dec. 6, 2011
(86) PCT No.: PCT/EP2011/071925

§ 371 Date: Sep. 19, 2013

(30) Foreign Application Priority Data
Dec. 6, 2010 (FR) 1060133

(51) Int. Cl. C03B 32/02

(52) U.S. Cl. CPC C03B 32/02
USPC 65/33.3; 65/30.1

(57) ABSTRACT

A process is provided for obtaining a glassy material that is optically transparent to infrared radiation. The process includes: a step of amorphization, by mechanosynthesis, of an assembly of starting elements including at least one metallic element and at least one chalcogenide element, making it possible to form an amorphous powder; a step of hot densification, in a mould of predetermined dimensions, of the amorphous powder, making it possible to obtain a glass; and heat treatment, carried out during or after the hot densification step, in which the glass is heated to a temperature at which a portion of the glass is converted from an amorphous state to a crystalline state, making it possible to obtain, after cooling, a glass-ceramic.

### CROSS-REFERENCE TO RELATED APPLICATIONS

This application is a Section 371 National Stage Application of International Application No. PCT/EP2011/071925, filed Dec. 6, 2011, which is incorporated by reference in its entirety and published as WO 2012/076527 on Jun. 14, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE INVENTION

The field of the invention is that of optical materials intended for the transmission of infrared electromagnetic radiation.

More specifically, the invention pertains to a technique for obtaining a vitreous material, such as a glass or a glass-ceramic that is chalcogenide-based and possesses transparency to infrared radiation.

Such materials have numerous applications, inter alia in the field of thermal imaging, and especially for the designing of passive optical components for infrared systems (heat cameras, heat sensors, etc), the fabrication of active optical components using optical properties of emission or of non-linearity such as infrared laser devices, optical switches or again optical amplifiers for example.

### TECHNOLOGICAL BACKGROUND

Chalcogenide glasses, used for example as materials for transmission in the infrared, presently constitute an economically valuable alternative to monocrystalline germanium for manufacturing massive optical elements working in the infrared.

There is a technique for preparing chalcogenide glasses, well known to those skilled in the art and presented in the scientific article <<Production of complex chalcogenide glass optics by molding for thermal imaging>> (Journal of Non-Crystalline Solids, vol. 326&327 (2003), p. 519-523—X. H. Zhang, Y. Guimond, Y. Bellec) and the patent document FR 2857354, that relies on the use of a silica tube. This technique comprises mainly the following steps:
introducing the initial elements needed to synthesize a chalcogenide glass in the desired stoichiometric proportions into a silica tube and vacuum-sealing said tube;
heating the silica tube, for several hours to bring it above the melting temperature (denoted as T_{f} here below) of the main initial element or elements, T_{f} possibly varying from 700 to 1000° C. for example;
carrying out a thermal quenching of the silica tube in water or air so as to obtain a glass;
extracting the glass from the silica tube after cooling.

The synthesis of chalcogenides glass in the silica tube is therefore a constrictive and costly technique. Indeed, this known technique has a certain number of drawbacks which are explained here below.

First of all, the implementing of a thermal cycle at very high temperature for hours give rise to high energy consumption and therefore to a relatively high cost of the production of glasses.

Then, the step for removing the glass from the silica tube very frequently makes it necessary to cut out the silica tube, and this irremediably leads to the deterioration of the silica tube. Thus, once the glass has been synthesized, the silica tube can no longer be re-utilized, thus increasing the cost price of the glasses. Furthermore, in order to obtain an ideal diameter for a desired application, the glasses are extracted from a glass that has been pre-synthesized by a coring operation, for example, (with loss of matter or of the initial purity in the case of recycling).

Another drawback related to the process of thermal amorphization lies in the fact that the silica tubes have relatively low thermal conductivity limiting, firstly, the range of glass compositions that can be envisaged during synthesis and, secondly, the size of the fabricated glasses. Indeed, the low thermal conductivity of the silica tubes is an obstacle to obtaining sufficiently high quenching speeds needed for preparing certain glass compositions, especially for glasses that have low stability in crystallization and large diameters.

It may be recalled that a glass is considered to have low stability in crystallization when the difference between the glass transition temperature T_{g} and its crystallization temperature (here below denoted as Tₓ) is lower than 100° C. Thus, when a thermal quenching is performed, the temperature gradient appearing within the “quenched material” can favor a reorganization of the molecules in the most remote part of the walls of the silica tube, and therefore crystallization. For the same reason, the greater the diameter of the silica tube, the greater the risk that the finally formed massive material will have a crystalline state.

It would therefore appear to be particularly worthwhile to be able to synthesize a chalcogenides-based vitreous material in a relatively simple and low-cost manner, without in any way thereby limiting the size of the synthesized material or the range of the compositions.

### SUMMARY OF THE INVENTION

One particular embodiment of the invention proposes a method for obtaining a material that is vitreous and optically transparent to infrared radiation, such a method comprising the following steps:
amorphization, by mechanosynthesis, of a set of initial elements comprising at least one metallic element and at least one chalcogenide element, making it possible to form an amorphous powder;
hot densification, in a molding device of predetermined dimensions, of the amorphous powder making it possible, after cooling, to obtain a massive glass.

The general principle of this embodiment consists therefore in preparing a massive vitreous material that is optically transparent to infrared radiation, the process of amorphization of which is achieved by mechanosynthesis, i.e. by an addition of mechanical energy at low temperature leading to the formation of an amorphous powder. The vitreous material is formed by means of a mechanism of hot densification, in a molding device, of the amorphous powder preliminarily formed, the dimensions of this powder being a function of the dimensions of the molding device.

Thus, this particular embodiment of the invention relies on a wholly novel and inventive approach in which, by mechanosynthesis, there is obtained a modification of the crystallographic structure, in passing from a crystalline state (initial elements) to a non-crystalline state (amorphous powder) in order to obtain a glass.

Thus, instead of preparing a vitreous material by means of a thermal oxidation process, which requires thermal treatment at very high temperature followed by quenching using a silica tube, the present invention relies on a process of mechanical amorphization achieved at ambient temperature. Such a process therefore consumes far less energy and is simpler to implement.

Besides, by overcoming the drawbacks related to the use of a silica tube, the chemical compositions making it possible to obtain a exploitable vitreous material are no longer limited solely to materials stable in crystallization and can be extended to any type of vitreous material including vitreous material which where hitherto impossible to prepare.

In addition, the process of mechanical amorphization offers no constraint in terms of maximum size of the vitreous material that can be ultimately obtaining except for the dimensions of the mold used for the hot densification step.

Advantageously, said step of hot densification is followed by a step of thermal treatment in which said massive glass obtained is heated to a temperature at which a part of said glass obtained is converted from an amorphous state into an substantially crystalline state which, after cooling, gives a glass-ceramic.

A glass-ceramic can therefore be obtained by specific thermal treatment of a glass that has the same composition but is free of crystals i.e. has a non-crystalline state. A glass-ceramic therefore takes the form of a glass matrix (amorphous state) in which crystals or nanocrystals are homogeneously distributed. Combining the advantages of ceramics and glass, it improves the mechanical and thermal properties of the vitreous material while at the same time preserving the transparency in the infrared spectrum.

According to one alternative embodiment, the method comprises a step of thermal treatment, performed during said step for hot densification, in which said massive glass obtained is heated to a temperature at which a part of said massive glass obtained is converted from an amorphous state to a substantially crystalline state, making it possible to obtain a glass-ceramic after cooling.

Since the thermal treatment is done at the same time as the hot densification step, the time needed to obtain a glass-ceramic is optimized.

According to one advantageous characteristic, said at least one metal element belongs to the group comprising Ge, As, Sb, Ga, Sn, In, in a content of 0 to 35 mol %, and said at least one chalcogenide element belongs to the group comprising S, Se, Te, in a content of 40 to 90 mol %.

These initial elements make it possible to prepare a glass or a glass-ceramic for the designing of components using optical properties (such as infrared lenses for example).

Advantageously, said set of initial elements comprises at least one element belonging to the group comprising:
a Er, Nd, Dy, Yb, Tm, Gd, Tb, Ce, Pr, Sm, type rare earth in a content of 0 to 15 mol %;
a CsX, KX, NaX, LiX type alkali halide, in a content of 0 to 60 mol %, X representing at least one atom of Cl, Br, I, F;
a Cu, Pb, Bi, Cd, Cr, Ag type metal, in a content of 0 to 20 mol %.

These initial elements make it possible to prepare glasses and glass-ceramics for the designing of components working on the basis of active optical properties (such as laser sources or optical amplifiers for example).

Advantageously, said step of hot densification is performed by uniaxial pressing.

This technique is simple and costs little to implement.

According to one alternative embodiment, said step of hot densification is performed by isostatic pressing.

This technique is also simple and costs little to implement.

According to another alternative embodiment, said step of hot densification is performed by a technique of spark plasma sintering (or SPS).

This technique further optimizes the time needed to obtain a vitreous material.

In another embodiment, the invention proposes an optical device comprising a vitreous material that is optically transparent to infrared radiation obtained according to the above-mentioned method (in any one of its different embodiments), such an optical device working in a range of infrared wavelengths extending from 400 nm to 25 μm.

### LIST OF FIGURES

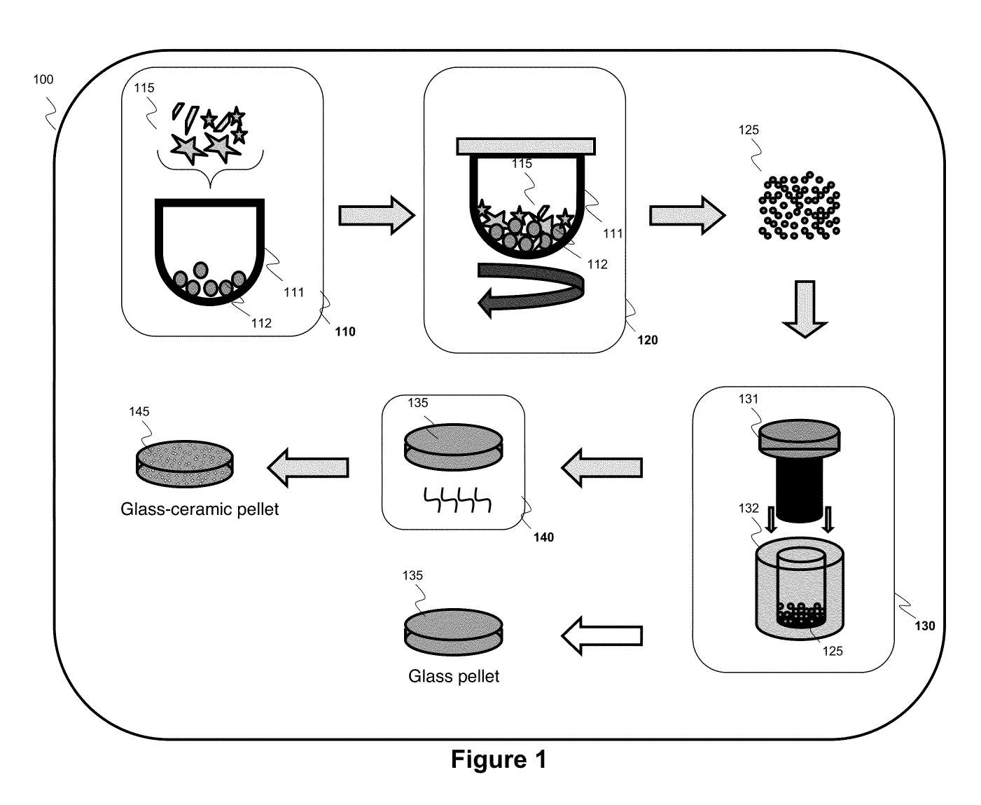

Other features and advantages of the invention shall appear from the following description given by way of an indicative and non-exhaustive example, and from the appended drawing, where FIG. 1 is a flowchart of a particular embodiment of the method according to the invention.

### DETAILED DESCRIPTION

FIG. 1 is a flowchart 100 of a particular embodiment of the method according to the invention.

The method consists in synthesizing a vitreous material that is optically transparent to an infrared, electromechanical radiation, the amorphization phase of which is obtained by an addition of mechanical energy.

Here below in the description, a “vitreous material” is understood to mean a chalcogenide-based glass or a glass-ceramic that possesses transparency in the infrared spectrum.

A step 110 introduces a set of initial elements 115 into a planetary ball mill for purposes of mechanical treatment. The initial elements 115 constitute the elementary products (in the form of powder or massive pieces) needed to obtain a vitreous material and comprise:
one or more metal elements chosen from among Ge, As, Sb, Ga, Sn, In, generally present in a content varying from 0 to 35 mol %; and
one or more chalcogenide elements chosen from among S, Se, Te, generally present in a content varying from 40 to 90 mol %.

These initial elements are introduced in a stoichiometric proportion according to the chemical composition that it is desired to obtain.

The planetary ball mill is constituted by one or more grinding jars 111 made of tungsten carbide, comprising a plurality of balls 112 also made of tungsten carbide.

In a step 120, each grinding jar 111 is subjected to two motions of rotation, namely: a first motion of rotation exerted on the bowl itself in one sense and a second motion of rotation exerted in the reverse sense and at identical speed (varying from 200 to 550 rpm⁻¹ for example), on a tray (not illustrated in the FIGURE) supporting the jar or jars. The centrifugal forces resulting from these two motions of rotation produce very-high-energy effects of impact and mechanical friction between the balls 112 themselves and against the walls of the jar so as to finely grind all the initial elements 115 preliminarily introduced into the jar 111. The mechanical impact of the balls 112 makes it possible, by mechanosynthesis, to amorphize the mixture constituted by the initial elements until an amorphous and homogenous powder 125 is obtained. Indeed, the mechanical energy contributed by this technique gradually converts the mixture of initially crystalline initial elements into an amorphous powder, the chemical composition of which depends on the quantity of each element introduced into the jar 111. The particles of the amorphous powder 125 generally have a size smaller than one micrometer. It must be noted that the step of amorphization by mechanosynthesis is done at ambient temperature.

It must be noted that, contrary to a classic grinding, such as the one made on a ceramic for example, the mechanical treatment of the step 120 is aimed not solely at changing the grain size of the particles (i.e. modifying the size or the shape of the particles) but also at modifying the crystallographic structure of the mixture of initial elements in making the mixture pass from a crystalline state to a non-crystalline state, i.e. an amorphous state.

Thus, instead of preparing a vitreous material by means of a process of thermal amorphization (prior art technique requiring a thermal treatment at very high temperature followed by a quenching operation), the present invention relies on a process of mechanical amorphization performed at ambient temperature, consuming far less energy.

In addition, in removing the need for the silica tube, the chemical compositions are no longer limited to vitreous materials that are stable in crystallization and can be extended to all types of vitreous material, that were hitherto impossible to prepare or, at least, incapable of being exploited by the above-mentioned prior-art technique.

Finally, mechanical amorphization offers no constraint of maximum size of the vitreous materials finally obtained, except for the dimensions of the mold used in the step 130 described in detail here below.

After the amorphous powder 125 has been formed, it is introduced into a cylindrical mold 132 with a 20-mm diameter and, in a step 130, undergoes a thermal and mechanical treatment of hot densification (also commonly called sintering). In this step, the amorphous powder 125 is brought to a temperature T below the melting temperature T_{f} of the main element or elements of the mixture. At the same time, it is compacted by application of a uniaxial stress (of the order of some tonnes) by means of a hydraulic jack 131, so as to prompt the creation of bonds between the particles without allowing the main element or elements of the mixture to reach melting point. More specifically, the amorphous powder 125 is heated for a predetermined duration (of the order of some hours) in the mold 132 at a densification temperature T_{d} higher than the glass transition temperatures, the predetermined duration and the temperature T_{d} being defined as a function of the chemical composition of the vitreous material prepared.

For example, for a glass having the composition GeSe4, the amorphous powder is hot densified for about one hour at a temperature T_{d} appreciably equal to 350° C.

The glass transition temperature T_{g} can be determined classically by means of a differential thermal analysis technique known as DSC (or Differential Scanning calorimetry).

A densification of the powder then occurs by hot compacting leading to a malleable, amorphous material whose shape and dimensions are defined by the imprint of the mold 132 and the viscoplastic properties of a vitreous material when it is heated above its glass transition temperature T_{g}, enable it to be easily shaped in the mold. Thus, it is enough to adapt the dimensions of the mold to obtain a massive vitreous material according to the dimensions desired.

After cooling, a glass pellet 135 is obtained with a diameter of 20 mm.

The hot densification step is herein obtained by uniaxial pressing. However, as an alternative, it can also be obtained by isostatic pressing or again according to an SPS (Spark Plasma Sintering) technique.

In one particular embodiment, the glass pellet 135 undergoes an additional step 140 of heat treatment with a view to ceramization. To this end, the glass pellet 135 is taken, for a duration of variable length (of the order of a few hours to a few tens of hours depending on the size and quantity of the crystals desired), to a ceramization temperature T_{c} higher than the glass transition temperature T_{g} but lower than the temperature of densification T_{d} applied preliminarily during the step 130.

After cooling, a glass-ceramic pellet 145 with a diameter of 20 mm is obtained.

A glass-ceramic is therefore obtained by specific thermal treatment of a glass that has a same composition but is free of crystals (glass pellet 135), i.e. a glass that has an amorphous (or non-crystalline) state so as to be capable of prompting its partial crystallization. A vitreous material is considered to be amorphous if it does not diffract X-rays under XRD (X-ray diffraction) analysis and if observation under an electron microscope does not reveal any presence of crystals or nanocrystals. A glass-ceramic therefore has a glass matrix (an amorphous state) in which crystals are homogenously distributed. These crystals generally have a size smaller than one micrometer.

For example, it is possible to obtain a crystallization rate (or crystallized volume) of nearly 60% of Ga₄GeSe₈ type crystals from a glass with a composition 80GeSe₂-20Ga₂Se₃, the Ga₄GeSe₈ crystals having a size of the order of about a hundred nanometers.

Thus, by combining advantages of ceramics and advantages of glasses, a thermal treatment of this kind improves the mechanical and thermal properties of the material (robustness, low thermal expansion, etc), while at the same time remaining compatible with an infrared application.

In one alternative embodiment, the thermal ceramization treatment and the step 130 of hot densification are done simultaneously in a same step, in order to optimize the duration of synthesis of the vitreous material. In this case, the amorphous powder 125 is taken to the temperature T_{d} and hot densified for one or two hours, and then taken to the temperature T_{c} for a duration of variable length (of the order of some hours to some tens of hours) depending on the size and quantity of crystals desired.

In this way, a glass-ceramic pellet is obtained directly after the performance of a step combining the processes of hot densification and ceramization.

Here below, we present an example of parameters needed to obtain a chalcogenide glass with a GeSe4 composition according to the method of the invention.

To go to the step of amorphization by mechanosynthesis, pieces of germanium and selenium (initial products) are introduced in metal form and in stoichiometric proportions into a 125-ml grinding jar or bowl. This, for this composition, 40 g of initial products represent: 7.48 g of germanium (40 g×0.20) and 32.52 g de selenium (40 g×0.80). The ratio between the mass of the initial products and that of the tungsten balls is appreciably equal to 10%. The following grinding parameters are then applied:
rotation speed of the grinding jar: 400 rpm;
20-mm-diameter tungsten balls;
grinding cycle comprising: 3 minutes in one sense, then a 3-minute pause and then 3 minutes in the opposite sense;
total grinding duration: 100 hours at ambient temperature.

A step is then performed of hot densification by uniaxial compacting with the following parameters:
2 g of amorphous powder of GeSe₄ obtained at the end of the amorphization step, introduced into a cylindrical mold with an internal diameter equal to 20 mm;
pressure applied by the hydraulic jack: about 4 MPa (pressure exerted by a one-tonne mass);
temperature of densification T_{d}=350° C.;
total duration of hot densification: 1 hour.

After cooling, the material obtained is a glass with a GeSe4 composition and takes the form of a 20-mm-diameter pellet. This material can be incorporated into an optical device such as for example, a thermal imaging device, working in the 3-5 μm and 8-13 μm atmospheric transparency windows. Indeed, GeSe4 glass has a transparency window extending from 700 nm to 16 μm.

It must be noted that the parameters to be applied during the steps of amorphization by mechanosynthesis and hot densification are within the scope of those skilled in the art. They depend on the composition of the material prepared.

In one particular embodiment, the initial elements may comprise, in addition to the metal elements and chalcogenides referred to further above, at least one of the following elements (the list is non-exhaustive);
a Er, Nd, Dy, Yb, Tm, Gd, Tb, Ce, Pr, Sm type rare earth, with a content of 0 to 15 in mol %;
a CsX, KX, NaX, LiX type alkali halide present in a content of 0 to 60 in mol %, X being at least an atom chosen from among the Cl, Br, I, F type halogens;
a Cu, Pb, Bi, Cd, Cr, Ag, type metal present in a content of 0 to 20 in mol %;

These elements are said to be “active” because, when they are incorporated into the initial mixture, they make it possible to dope the vitreous material obtained after synthesis and give it active optical properties that are particularly valuable for certain infrared applications, for example for manufacturing optical components based on laser sources and optical amplifiers.

The following examples, given by way of purely illustratory and non-exhaustive examples, give an account of some of the compositions forming the basis of glasses and/or glass-ceramics that could be obtained by the method of the invention, namely: GeSe₄, GeS₂, 80GeSe₂-20Ga₂Se₃, 80GeS₂-20Ga₂S₃, 62.5GeS₂-12.5Sb₂-S₃-25CsCl, GeS_{1.8}. It must be noted that, for the GeS₂, 80GeS₂-20Ga₂S₃ and 62.5GeS₂-12.5Sb₂S₃-25CsCl compositions, the maximum diameter obtained by the prior art technique is 10 mm, while the diameter that can be obtained with the method of the invention depends only on the size of the mold used during the hot densification step. For the GeS1.8 composition (low-stability glass), the maximum diameter obtained by the prior-art technique does not go beyond 8 mm, while the diameter that can be obtained with the method of the invention depends solely on the size of the mold used during the hot densification step. Thus, since the process of amorphization by mechanosynthesis removes the drawbacks related to thermal amorphization, it is possible to obtain chalcogenide-based glasses or glass-ceramics with large diameters, i.e. diameters greater than 50 mm, thus meeting all the industrial requirements in the context of current infrared applications.

The vitreous materials obtained according to the method of the invention can be used in an optical device working in a range of infrared wavelengths, at least from 400 nm to 25 μm.

An embodiment of the invention provides a technique for obtaining a vitreous material that is optically transparent to infrared radiation, and is simple and costs little to implement.

An embodiment of the invention provides a technique of this kind that does not limit the preparation of materials solely to materials stable in crystallization. In other words, this removes the character of instability in crystallization of certain glass compositions, and therefore enables preparation of novel glass compositions that can be exploited in industry.

An embodiment of the invention also provides a technique that has no constraints as regards the dimensions of the material prepared.

Although the present disclosure has been described with reference to one or more examples, workers skilled in the art will recognize that changes may be made in form and detail without departing from the scope of the disclosure and/or the appended claims.

1. A method for obtaining a material that is vitreous and optically transparent to infrared radiation, wherein the method comprises the following steps:
amorphization, by mechanosynthesis, of a set of initial elements comprising at least one metallic element and at least one chalcogenide element, making it possible to form an amorphous powder;
hot densification, in a molding device of predetermined dimensions, of the amorphous powder making it possible to obtain a glass; and
thermal treatment, performed during or after said step of hot densification, in which said glass is heated to a temperature at which a part of said glass is converted from an amorphous state into an substantially crystalline state, making it possible to obtain, after cooling, a glass-ceramic type of massive glass.

2. The method according to claim 1, wherein said at least one metal element belongs to the group comprising: Ge, As, Sb, Ga, Sn, In, in a content of 0 to 35 mol %, and wherein said at least one chalcogenide element belongs to the group comprising: S, Se, Te, in a content of 40 to 90 mol %.

3. The method according to claim 1, wherein said set of initial elements further comprises at least one element belonging to the group comprising:
an Er, Nd, Dy, Yb, Tm, Gd, Tb, Ce, Pr, Sm, type of rare earth in a content of 0 to 15 mol %;
a CsX, KX, NaX, LiX type alkali halide, in a content of 0 to 60 mol %, X representing at least one atom of Cl, Br, I, F;
a Cu, Pb, Bi, Cd, Cr, Ag type metal, in a content of 0 to 20 mol %.

4. The method according to claim 1, wherein said step of hot densification is performed by uniaxial pressing.

5. The method according to claim 1, wherein said step of hot densification is performed by isostatic pressing.

6. The method according to claim 1, wherein said step of hot densification is performed by a technique of spark plasma sintering (SPS).
